(19) United States
(12) Patent Application Publication
(10) Pub. No.: US 2025/0272165 A1
(43) Pub. Date: Aug. 28, 2025

(54) ACTION PRESETS FOR INTENT DRIVING ACTION MAPPING

(71) Applicant: Zapier, Inc., San Francisco, CA (US)

(72) Inventors: Tal Peretz, San Francisco, CA (US); Harrison B. Jackson, San Francisco, CA (US); Taylor Halliday, San Francisco, CA (US); Vitor Balocco, San Francisco, CA (US); Nathaniel Moore, San Francisco, CA (US); Andrew Berman, San Francisco, CA (US); Reid Robinson, San Francisco, CA (US); Michael Knoop, San Francisco, CA (US); Nikita Danilov, San Francisco, CA (US)

(21) Appl. No.: 19/065,497

(22) Filed: Feb. 27, 2025

Related U.S. Application Data
(60) Provisional application No. 63/559,089, filed on Feb. 28, 2024.

(51) Int. Cl. G06F 9/54; G06F 16/22

(52) U.S. Cl. CPC G06F 9/541; G06F 16/22

(57) ABSTRACT

A method and system for action preset based application programming interface (API) call is disclosed. In some embodiments, the method includes receiving a natural language instruction from a user, processing the natural language instruction to extract a set of parameters through a large language model, comparing the extracted parameters against a preset database to find a matching action preset, formatting an API request by combining the extracted parameters with default values obtained from the matching action preset, and sending the formatted API request to an external API endpoint to execute the API request.

### CROSS REFERENCE TO RELATED APPLICATION

This application claims the benefit of U.S. Provisional Patent Application No. 63/559,089, titled “Action Presets for Intent Driving Action Mapping,” and filed on Feb. 28, 2024, the entire content of which is incorporated by reference herein.

### TECHNICAL FIELD

This disclosure relates to user interactions with specific applications, and more particularly to a combination of predefined parameter sets (presets) associated with specific actions and applications for intent-driven API action mapping.

### BACKGROUND

Application programming interfaces (APIs) enable communication between different software programs, allowing them to exchange data and functionality. An API call, also referred to as an API request, is a message sent to a server requesting specific information or services from an API. Traditionally, these calls require structured inputs, but with advancements in large language models (LLMs) and other artificial intelligence (AI) models, it is now possible to generate API calls using natural language inputs. This allows users to interact with APIs through chatbots, virtual assistants, and other AI-powered interfaces, where the AI interprets the request and formulates an appropriate API call based on contextual understanding.

However, AI-generated API calls relying on inferred requests introduce certain challenges. These include low accuracy, where the AI may misinterpret user intent and generate incorrect API parameters, low efficiency, as additional processing may be required to refine requests, and inconsistencies across different AI models, leading to variations in API call structures. These limitations highlight the need for a more structured approach to natural language-based API execution, ensuring precision, reliability, and uniformity across different AI-assisted API interactions.

### SUMMARY

To address the aforementioned shortcomings, a method and a system for action preset based API call are disclosed herein. The method includes receiving a natural language instruction from a user, processing the natural language instruction to extract a set of parameters through a large language model, comparing the extracted parameters against a preset database to find a matching action preset, formatting an API request by combining the extracted parameters with default values obtained from the matching action preset, and sending the formatted API request to an external API endpoint to execute the API request.

The above and other preferred features, including various novel details of implementation and combination of elements, will now be more particularly described with reference to the accompanying drawings and pointed out in the claims. It will be understood that the particular methods and apparatuses are shown by way of illustration only and not as limitations. As will be understood by those skilled in the art, the principles and features explained herein may be employed in various and numerous embodiments.

### BRIEF DESCRIPTION OF THE DRAWINGS

The disclosed embodiments have advantages and features which will be more readily apparent from the detailed description, the appended claims, and the accompanying figures (or drawings). A brief introduction of the figures is below.

FIG. 1 illustrates an example overall flow diagram of action preset based API call, according to some embodiments.

FIG. 2 illustrates an example action mapping system architecture, according to some embodiments.

FIG. 3 illustrates an example method for defining action presets, according to some embodiments.

FIG. 4 illustrates an example method for score-based preset matching, according to some embodiments.

FIGS. 5A-5C illustrate various preset scores determined for corresponding user instructions, according to some embodiments.

FIG. 6 illustrates an example method for executing an API call, according to some embodiments.

FIG. 7 illustrates an example method for executing a preset based API call, according to some embodiments.

FIG. 8 is a block diagram of an example computer system for implementing the technology described herein, according to some embodiments.

### DETAILED DESCRIPTION

The figures (FIGS.) and the following description relate to some specific embodiments by way of illustration only. It should be noted that from the following descriptions, alternative embodiments of the methods and systems disclosed herein will be readily recognized as viable alternatives that may be employed without departing from the principles of what is claimed.

Reference will now be made in detail to several embodiments, examples of which are illustrated in the accompanying figures. It is noted that wherever practicable, similar or like reference numbers may be used in the figures and may indicate similar or like functionality. The figures depict embodiments of the disclosed systems or methods for purposes of illustration only. One skilled in the art will readily recognize from the following descriptions that alternative embodiments of the structures and methods illustrated herein may be employed without departing from the principles described herein.

As described earlier, an action mapping system aims to improve the accuracy and efficiency of natural language-based API calls. However, several technical challenges arise when AI models interpret user instructions and attempt to generate precise API requests. Below, the key technical problems and their corresponding solutions provided by the disclosure are briefly described.

One of the main issues in the existing mapping systems is low accuracy in API calls. When users provide instructions in natural language, AI models often struggle to interpret parameters correctly or select the appropriate action. Since AI models rely on pattern recognition rather than strict API structures, they may generate incomplete or incorrect API requests. Additionally, users may phrase the same request in different ways, making it even harder for the AI to consistently extract the necessary details. For example, if a user says “schedule a meeting with John tomorrow,” an AI model might generate an API request that lacks essential parameters such as the time or participant details. This leads to errors or failed API executions.

To address this, the action mapping system disclosed herein may leverage structured action presets. Instead of relying on AI-generated guesses, a predefined database of action presets may be created and used to map natural language inputs to structured API requests with clearly defined parameters. When the system receives a user instruction, it extracts the relevant values and matches them to the most suitable action preset, ensuring a significantly higher level of accuracy.

Another critical problem in the existing mapping systems is low efficiency in AI-driven API calls. Without predefined mappings, AI models often take longer to process natural language inputs, analyze possible actions, and construct a request. This inefficiency becomes even more noticeable when dealing with complex workflows that involve multiple API calls. For instance, if a user asks “send an email to my team and schedule a follow-up meeting next Monday,” a general AI model may take multiple processing steps to determine the required API calls, potentially delaying execution.

The solution to this inefficiency lies in a well-structured preset database disclosed herein that enables fast lookups. By storing a large number of action presets, the system disclosed herein may quickly determine the correct API request instead of generating one from scratch every time. This may eliminate the need for real-time guessing and reduce processing latency. Furthermore, predefined action presets may ensure that API calls remain consistent across different users and scenarios, reducing the risk of errors caused by model variability.

Another significant challenge in the existing mapping systems is inconsistency across AI models. Since different AI-powered assistants or chat models may generate varying interpretations of the same input, API calls may differ depending on the AI handling the request. This variation makes it difficult to maintain standardized workflows, especially in enterprise environments where consistency is crucial. For instance, if two users ask, “fetch my last five invoices,” one AI model might generate a request to fetch the invoices from a finance system, while another might mistakenly pull unrelated financial data.

To solve this problem, the action mapping system disclosed herein may ensure standardized API request generation by enforcing preset based mappings. Instead of allowing AI models to determine API structures independently, the system may use predefined templates for each supported API action. This approach may guarantee that all users receive the same, correct API response regardless of slight variations in phrasing or the AI model used.

By addressing these challenges such as low accuracy, inefficiency, and inconsistency, the action mapping system disclosed herein may significantly enhance the reliability of AI-driven API calls. The disclosed action presets for intent driving action mapping may enable a faster, more precise, and standardized approach to processing natural language instructions, ultimately improving automation and system integration in various applications.

It is to be noted that the benefits and advantages described herein are not all-inclusive, and many additional features and advantages will be further described under the context of specific embodiments. In addition, some additional features and advantages will become apparent to one of ordinary skill in the art in view of the figures and the following descriptions.

### System Overview

The action mapping system disclosed herein includes an action mapping tool that helps match user instructions into precise API calls, or more specifically, expected actions or applications. Specifically, the user instructions may be instructions provided by a user in natural language. One example user instruction may be “look for an event A in a calendar.” The user may provide the instruction in natural language, such as through voice chat or Google Assistant. The action mapping system disclosed herein may automatically map the instruction into an API call that looks for the event A in the calendar. In some example applications, a user instruction may be more complicated, and an API call may be not easily and directly extracted from the user instruction. In such circumstances, certain values for parameters associated with actions may be first extracted from the user instruction. The extracted values may be then compared to the predefined action presets (which are combinations of parameters and associated actions or simply “action-parameter combinations”) to determine the corresponding action. It should be noted that, while the action presets disclosed herein are described with reference to API interactions or API calls, the disclosed action presets are not limited to such applications, but may be used in other situations. For example, the action presets disclosed herein may simplify the experience of automation platforms from the user experience (UX). Instead of searching APIs and configuring all the fields manually, by exposing action presets, a user may only fill the minimal fields necessary if there is any. This would mean when using a UX to build out automation, a user may search for what the user wants to build, which results in much fewer fields (e.g., 1.5 to 10× fewer fields) the user needs to fill out to complete the automation steps.

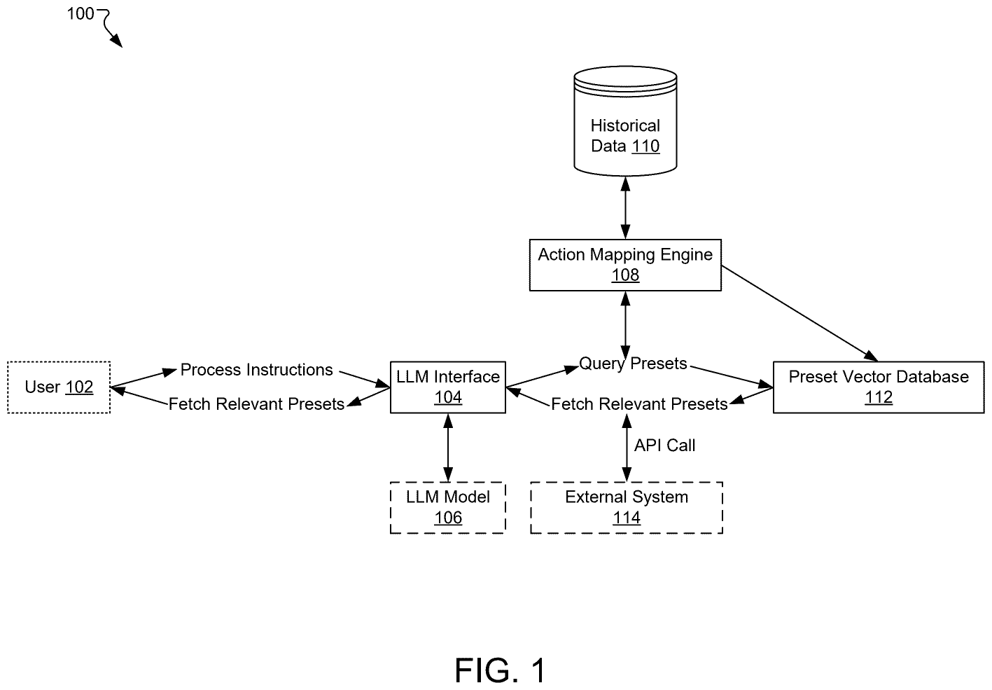

FIG. 1 illustrates an example overall flow diagram 100 of action preset based API call, according to some embodiments. As illustrated, the action mapping system includes an LLM interface 104 (which may be coupled to an LLM model 106), an action mapping engine 108, and a preset vector database 112. It is to be noted that while the disclosure uses the LLM model 106 in the illustrated embodiment, the present disclosure is not limited to the LLM model, but rather can use many other similar AI models for parsing the parameters of an instruction or query from a user.

The preset vector database 112 may be an action-parameter mapping database containing a large number of predefined and indexed action-parameter combinations or mappings (also referred to as action presets). In one example, the preset vector database 112 may be a structured repository that stores a plurality of predefined action-parameter mappings. In some embodiments, the actions included in the preset vector database 112 may be AI actions, which are actions defined to respond to AI-supported API calls by users 102 using natural language. The predefined AI actions are optimized for receiving user input in natural language like video/voice/text chat, and Google Assistant, among other large language models. The AI actions may be considered more human-friendly integrations due to the adoption of natural language for user instructions. This allows a user with minimal or no technical skills to make an API call (e.g., to an external system 114), making the disclosed system more user-friendly and catering to a wider population. Example AI actions or user instructions provided by users in natural language may include but are not limited to sending messages in Slack, adding a row to a Google Sheet, drafting a new email in Gmail, searching for an event in a calendar, etc.

Referring back to FIG. 1, the parameters included in the preset vector database 112 may be LLM parameters that essentially define the behavior of an AI model in user instruction processing. These parameters may be the factors that an AI system learns from its training data and subsequently utilizes to make predictions. These parameters shape the AI's understanding of language, influencing how it processes input and formulates output. Each parameter is like a piece in a grand jigsaw puzzle, with the complete picture being a model's ability to generate human-like text. The architecture of an LLM may contain a large number of parameters, each contributing to the model's ability to generate human-like text. These parameters form the basis of the LLM model's linguistic abilities, driving its comprehension, generation, and contextualization of language. According to some embodiments, these parameters are associated with specific actions, so that each action may be uniquely identified based on the values associated with certain parameters. Accordingly, action-parameter combinations may be properly defined, which can be then used for parameter-related action mapping once these combinations are defined.

The LLM interface 104 may be a specifically configured interface that exposes an API layer to interface with a large language model 106, which may be an AI-based LLM model for parsing the user instructions to identify relevant actions included in the instructions. The AI-based LLM model disclosed herein is a large deep-learning model that may be pre-trained on vast amounts of data. The underlying transformer included in the model may be a set of neural networks that consist of an encoder and a decoder with self-attention capabilities. The encoder and decoder may extract meanings from a sequence of text and understand the relationships between words and phrases in it. AI-based LLM model thus has the ability to make predictions based on a relatively small number of user prompts or inputs.

The action mapping engine 108 may be configured to select appropriate presets based on the historical user behavior analysis (e.g., from historical data 110). As will be described in more detail later, the action mapping engine 108 may include an action mapping algorithm that compares the analyzed user instruction performed by the LLM model with action presets, and determines the closest preset (e.g., a top-ranked preset), which can be then used to determine an AI action corresponding to the user instruction. According to some embodiments, a scoring system or scoring engine may be created to rank the action presets in selecting a top-ranked candidate action preset, as will be described in detail later. Once the candidate action preset is determined, a corresponding API call may be generated and further executed through the external system 114, as will be described in detail later.

### Action Mapping System Architecture

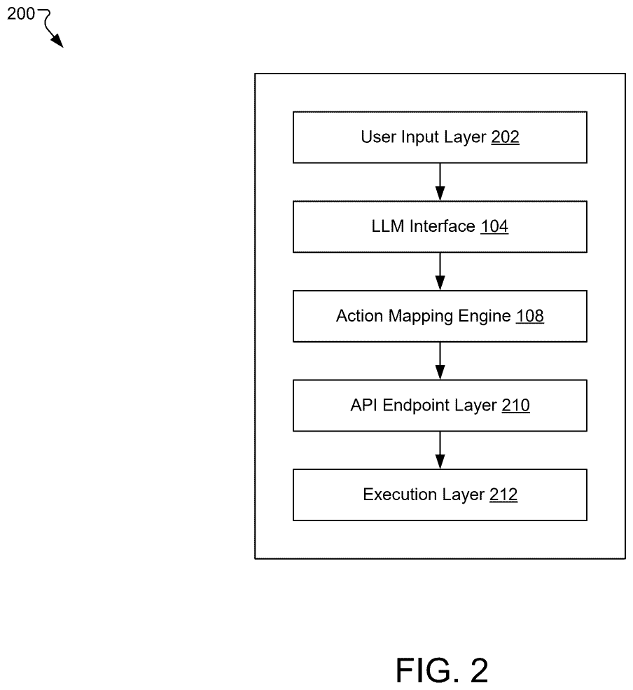

FIG. 2 illustrates an example action mapping system architecture 200, according to some embodiments. As illustrated, the action mapping system may include a user interface layer 202, an LLM interface 104, an action mapping engine 108, an API endpoint layer 210, and an execution layer 212.

The user interface layer 202 is the entry point where users provide instructions via different interfaces. These inputs may be in the form of text (e.g., chatbot, web API, command-line interface (CLI)) or voice (e.g., smart assistants like Siri, Alexa, Google Assistant). When users give commands through a chatbot or voice assistant, the voice input may be converted into text using a speech-to-text (STT) API (e.g., OpenAI Whisper, Google STT). Under certain circumstances, developers or specific users may interact via a REST API or CLI to provide instructions. An example user input may be “deploy the latest version of our app,” which may be passed to the LLM interface 104 for further processing.

The LLM interface 104 is configured to process natural language instructions (or queries). As described earlier, the LLM Interface 104 is responsible for understanding and processing user inputs using an AI-powered LLM such as GPT-4 or Claude. The specific function of the LLM interface 104 may include converting a user input into structured data by identifying key parameters (e.g., action type, parameters, application context). If a user provides an incomplete command (e.g., “turn off the lights”), the LLM interface 104 may be configured to further infer missing details based on context (e.g., default room settings, which room the instruction is received, which room has better sunlight). In some embodiments, the LLM interface 104 may further determine what the user wants to do and extract necessary details.

In an example processing, the LLM interface 104 may receive a text instruction “deploy the latest version of our app” from the user interface layer 202. The LLM interface 104 may extract parameters: {“action”:“deploy”, “app”:“my_app”, “version”:“latest”}. According to some embodiments, the extracted parameters may be structured in a standardized format for further processing by the action mapping engine 108.

In some embodiments, the parameters included in a preset may be categorized into “static” and “dynamic” based on the commonality and potential for user customization, as described in detail later. Accordingly, in some embodiments, the LLM interface 104 may be configured to further extract information relevant to dynamic fields defined in presets, which then allows the extracted information to be mapped to the corresponding dynamic fields in the preset format. In one example, the LLM interface 104 may be configured to automatically fill the extracted dynamic field values into the appropriate fields of the selected preset so that the preset can be prepared for execution based on the filled-in information. In some embodiments, the LLM interface 104 may collaborate with the API endpoint layer 210 to fill the extracted dynamic field values, e.g., through “Update” as will be described in detail later.

In some embodiments, the LLM interface 104 may further implement a feedback mechanism to refine the accuracy of the instruction parsing and dynamic field extraction. This may include a collection of user corrections and feedback to adjust the interpretation and extraction logic as needed. In some embodiments, an LLM model coupled to the LLM interface 104 may be continuously trained during the actual applications to further improve the accuracy of the LLM model in parsing the instructions.

The action mapping engine 108 may be configured to match the user input to a predefined API action, more specifically, match the extracted parameters from the LLM interface 104 to a predefined API action. As described earlier, this may include a mapping of the extracted parameters to a predefined action preset stored in the preset vector database 112.

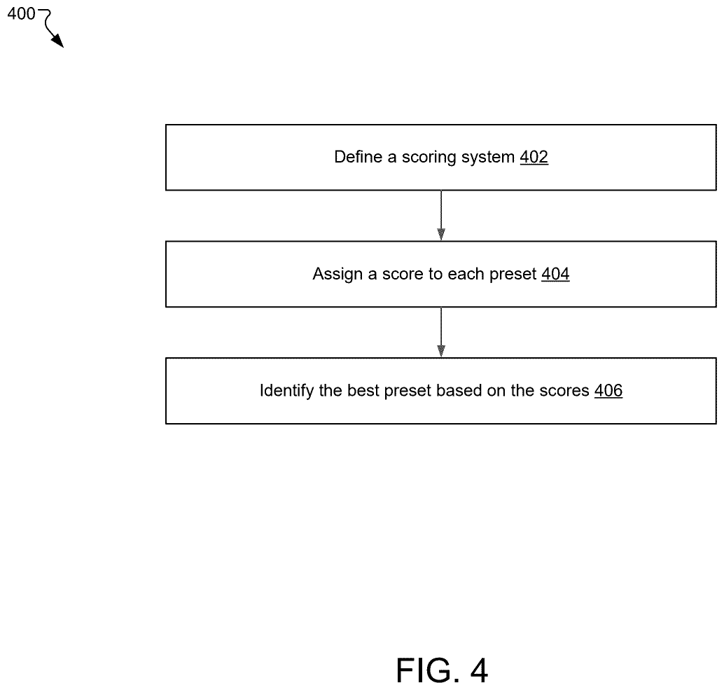

Specifically, the action mapping engine 108 may first extract parameters obtained from the LLM interface, such as action type, version number, application name, time, etc. The action mapping engine 108 then looks at the preset vector database 112 for a matching action preset based on extracted parameters. According to some embodiments, the action mapping engine 108 may include an action matching algorithm that is configured to determine the best preset based on similarity, priority, and contextual clues. According to some embodiments, the action matching algorithm may include a scoring mechanism or scoring system that generates a score of the possible matches and determines a preset with the highest score as the best preset. The specific details of the scoring mechanism are further described later in FIG. 4.

Here the following is an example matching process. The extracted parameters by the LLM interface 104 may be {“action”:“deploy”, “app”:“my_app”, “version”:“latest”}. The action mapping engine 108 may use these parameters to search the preset vector database 112, and then identify the best preset based on these parameters. The identified preset may include an action corresponding to an API request, which can be then forwarded to the API endpoint layer 210.

The API endpoint layer 210 may be configured to manage API calls included in the presets. According to some embodiments, the API endpoint layer 210 may include two main API endpoints, preset management API (e.g., create, read, update, and delete (CRUD) operations) and user instruction processing API. Example preset management API may include Create (POST/presets), through which to add new action presets to the database, Update (PUT/presets/{id}), through which to modify existing presets, Delete (DELETE/presets/{id}), through which to remove outdated presets, and Read (GET/presets), through which to fetch a list of all available presets. The user instruction processing API may process a user input from the LLM interface 104 and trigger the correct API action. In some embodiments, the user instruction processing API may further validate API requests before sending them for execution.

In one example API processing, the input into the API endpoint layer 210 may be {“app”:“my_app”, “version”:“latest”}, and the processed API call may be POST/deploy, and then the output of the API endpoint layer 210 may be a structured API request sent to the execution layer 212.

The execution layer 212 may be configured to execute the mapped API call output by the API endpoint layer 210. Briefly, the execution layer may be responsible for sending the mapped API request to an appropriate external system. For example, the execution layer 211 may ensure seamless automation by interfacing with smart home APIs (e.g., POST/lights/off to turn off smart home lights), DevOps automation (e.g., POST/deploy to trigger a new app deployment), enterprise workflows (e.g., POST/reports/sales to generate a sales report), and so on.

In one specific example execution, the API call sent to the external system may be POST/deploy, and the response from the system may be {“status”:“success”, “deployment_id”:12345}. Based on the response received from the external system, the execution layer 212 may generate a final response “deployment successful! ID: 12345,” which is then sent back to the user who provided the instruction.

### Specific Implementations

### Action Preset Creation

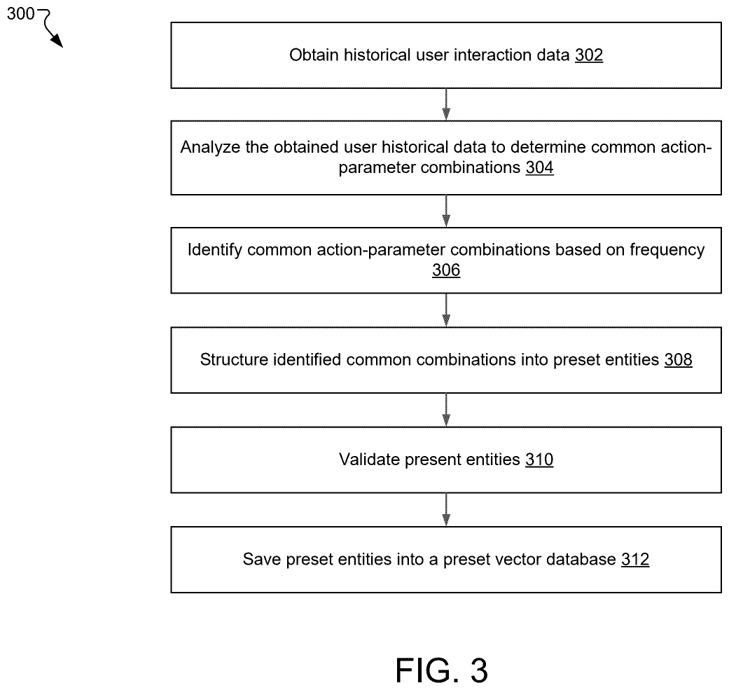

FIG. 3 illustrates an example method 300 for defining action presets, according to some embodiments. Briefly, the presets may be defined by utilizing historical user interaction data containing actions performed on certain applications, to identify common action-parameter combinations. The identified combinations are then structured into preset entities for later action-parameter mapping. In some embodiments, a large variety of historical user interaction data are utilized, so as to ensure broad coverage of user intents to be identified from the user instructions.

As illustrated in FIG. 3, the method 300, at step 302, obtains historical user interaction data. According to some embodiments, the historical user interaction data may be obtained from a platform that is integrated with a large number of applications. For example, the platform may allow to place certain AI-based API calls to different applications, such as Gmail, Google Calendar, Slack, Google Sheet, Microsoft Outlook, Discord, etc. When different users place these API calls through the platform, the user interactions with these different applications may be collected through the platform. When there are sufficient user interactions with different applications through API calls, these historical user interactions may allow to identify certain patterns between parameters associated with the actions conducted in the specific applications and respective actions. Accordingly, to define action presets, the disclosed action mapping system may access the historical data storage to retrieve the historical user interactions with the platform. In some embodiments, the retrieved user interactions may be further filtered to remove unsuccessful interactions (e.g., user instructions that did not trigger expected actions in the applications), so that only successful user interactions (i.e., expected actions are triggered) that are indicative of common action-parameter combinations are collected.

At step 304, the disclosed action mapping system further analyzes data to determine the frequencies of action-parameter combinations. Briefly, at the beginning stage, an empty dictionary may be initialized to hold action-parameter frequency. Then, for each successful user interaction (i.e., a user instruction (which may be also a user query) that triggered an expected action), the action key and the associated parameters may be extracted and used for the registration of an action-parameter combination as one count. Through the continuous analysis of the historical user interactions, the frequency of each certain action-parameter combination may be determined. Among these action-parameter combinations, some combinations show increased frequency count, while other action-parameter combinations may not change or rarely increase during the analysis of the historical user interaction data.

At step 306, the disclosed action mapping system identifies common combinations based on the frequencies (i.e., the counts) of action-parameter combinations. In one example, a threshold may be set for identifying common combinations based on the frequency. Only these combinations that have a frequency exceeding the threshold are considered common combinations, while the remaining combinations are not considered common combinations due to their rare occurrence.

At step 308, the disclosed action mapping system structures the identified common combinations into preset entities. Briefly, for each common combination, the action mapping system may create a new preset entity object, assign a unique preset identification (preset_id) and link the preset_id to a corresponding action identification (action_id). In some embodiments, the action mapping system may further categorize parameters included in a preset entity into “static” and “dynamic” based on the commonality and potential for user customization. For parameters that are categorized as static, the most common values found in the historical user interaction data may be used to fill in these parameters. On the other hand, for parameters that are categorized as dynamic, these parameters may be marked, to remind later fill-in of certain values for these dynamic parameters.

At step 310, the disclosed action mapping system further validates preset entities. Briefly, for each created preset entity, the entity structure and data integrity are checked. For example, it may be checked whether the static values for the static parameters are filled in, and the dynamic parameters are correctly marked. According to some embodiments, a test run may be further performed to ensure the preset entity executes as expected within the disclosed action mapping system. For example, a test run may be performed by placing the corresponding user instruction, and checking whether the associated action in the preset entity is performed.

At step 312, the disclosed action mapping system may further save the validated preset entity into a preset vector database, making it available by the action mapping system for matching an incoming user instruction.

In some embodiments, while not illustrated, the method 300 may additionally include a step of updating the preset catalog. For example, when there is a new action preset (i.e., a new action-parameter combination that has a high frequency), the system's preset catalog is updated to cover such a preset entity. In some embodiments, a dynamic management system for presets may be implemented, allowing for regular (e.g., weekly, monthly, quarterly, etc.) updates based on user feedback and changing usage patterns. In some embodiments, the preset catalog in the database is further indexed or at least searchable by key parameters, so as to facilitate a quick retrieval during user interaction mapping, resulting in a quick AI action.

Although not shown in FIG. 3, in some embodiments, the method 300 may further include a process of generating a log for the preset entity definition process. For example, any errors or issues encountered during the definition process may be registered. In some embodiments, a summary may be further generated for each new or updated preset entity added to the system, to allow a further review and/or customization if necessary.

Here the following is an example pseudo-code for analyzing common action-parameter combinations, which may be used for some steps in the method 300:

```
def analyze_and_identify_common_combinations(historical_data, threshold=10):
  # Expand the ‘parameters' dictionary into separate columns for each parameter.
  parameters_expanded = historical_data[‘parameters'].apply(pd.Series)
  # Concatenate the action column with the expanded parameters to get all combinations.
  historical_data_expanded = pd.concat([historical_data[[‘action’]], parameters_expanded],
  axis=1)
  # Generate a unique key for each action-parameter combination row-wise.
  historical_data_expanded[‘combination_key’] = (
  historical_data_expanded.apply(lambda row: f”{ row[‘action’] }:” +
  “,”.join(sorted([key for key in row.index if pd.notnull(row[key]) and key !=
  ‘action’])), axis=1)
  )
  # Count the occurrences of each combination.
  combination_counts = historical_data_expanded[‘combination_key’].value_counts( )
  # Filter combinations that meet or exceed the threshold.
  common_combinations = combination_counts[combination_counts >=
  threshold].reset_index( ) common_combinations.columns = [‘combination_key’, ‘count’]
  # Split the ‘combination_key’ to extract the ‘action’ and ‘parameters'.
  common_combinations[[‘action’, ‘parameter_keys']] =
  common_combinations[‘combination_key’].str.split(‘:’, expand=True)
  # Optionally, turn parameter keys back into lists from the string representation.
  common_combinations[‘parameter_keys'] =
  common_combinations[‘parameter_keys'].apply(lambda x:
  x.split(‘,’))
  return common_combinations[[‘action’, ‘parameter_keys', ‘count’]]
```

### Preset Vector Database

In the next, the specific structure of the action-parameter database (i.e., the preset vector database 112) is further described. In some embodiments, the action-parameter database may include action entities, which define the structure for individual actions that can be performed by the action mapping system or the external system associated with the action mapping system. Exemplary details for an action entity may include but are not limited to action key, name, type (e.g., read, write), requirements (necessary fields or parameters), and application association. Here the following is an example action entity:

```
  {
    “key”: “event_v2”,
    “meta”: { },
    “name”: “Find Event”,
    “noun”: “Event”,
    “type”: “search”, “needs”: [
      {
        “key”: “calendarid”,
        “type”: “unicode”,
        “label”: “Calendar”, “choices”: null,
        “prefill”: “calendar.id.summary”, “required”: true
      },
      {
        “key”: “search_term”, “type”: “unicode”,
        “choices”: null, “required”: false,
      },
      {
        “key”: “start_time”,
        “type”: “datetime”,
        “label”: “Start Time Before”, “choices”: null,
        “required”: false,
      },
      {
        “key”: “end_time”,
        “type”: “datetime”, “label”: “End Time After”,
        “choices”: null, “default”: “now”,
“required”: false,
      },
      {
        “key”: “ordering”,
        “type”: “unicode”,
        “label”: “Sort Order”,
        “choices”: null,
        “default”: “startTime”,
      }
    ],
    “app_name”: “Google Calendar”, “is_hidden”: false,
    “popularity”: null,
    “description”: “Finds an event in your calendar.”,
    “is_important”: true
  }
```

In some embodiments, the action-parameter database may also include a plurality of preset entities, which define the structure for stored action presets. Exemplary details for an action preset may include but are not limited to fields for the application identifier, action identifier, preset parameters, and metadata for usage tracking. Here the following is an example action preset entity:

```
  {
    “name”: “Find Today's Events”,
    “description”: “Finds the events for today in your selected
    calendar.”,
    “action_id”: “018cfac3-e8df-6650-6f21-ed7d149d9561”,
    “fields”: {
      “dynamic”: [
        “search_term”, // requires user/llm input
        “calendarid” // requires user/llm input
      ],
      “static”: [
        {
          “key”: “start_time”,
          “value”: “tomorrow”
        },
        {
          “key”: “end_time”,
          “value”: “today”
        },
        {
          “key”: “ordering”,
          “default”: “startTime”
        }
      ]
    }
  }
```

### Preset Matching

According to some embodiments, a scoring system may be explored to determine the best-matching preset when multiple candidates exist. Instead of a strict exact match (where all parameters must be identical), by assigning scores based on similarity, it can be ensured that the most relevant preset is selected.

FIG. 4 illustrates an example method for score-based preset matching, according to some embodiments. Briefly, at step 402, a scoring system is defined first. In one example, the scoring system may be defined based on the similarity match or comparison. In general, the higher the exact parameter match, the higher the score for a preset. If some parameters match but others are missing, assign a partial score. If required parameters are missing, certain points are further deducted. According to some embodiments, the scoring system may also use similarity scores for flexible word comparisons (e.g., “living room” vs. “lounge”). Table 1 below provides an example of scoring criteria for illustrative purposes but not for limitations.

TABLE 1

| Match Type | Score Contribution |
|---|---|
| Exact action match | +5 points |
| Exact device match | +3 points |
| Exact location match | +2 points |
| Time match (if applicable) | +1 point |
| Partial match (e.g., synonym for location) | +1 point |
| Missing key parameter | −3 points |

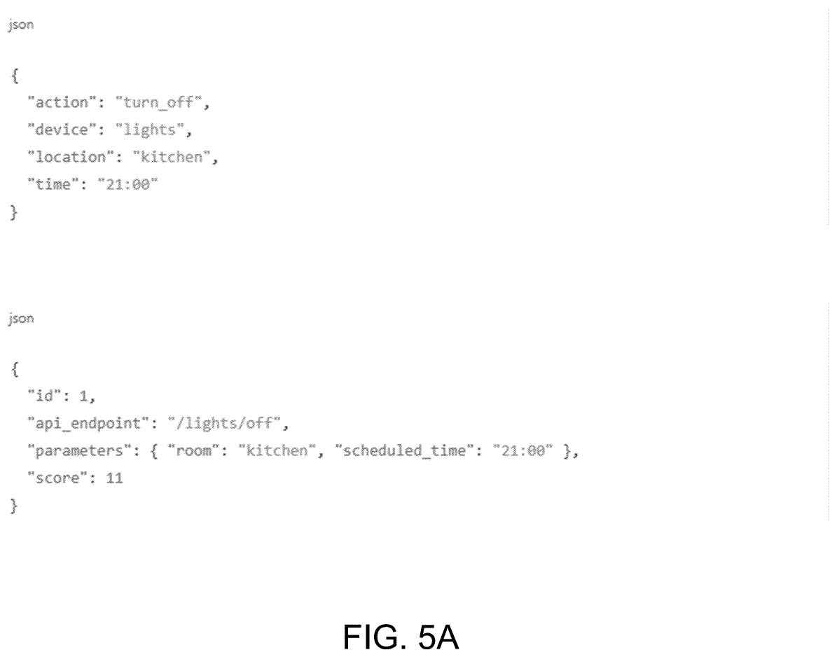

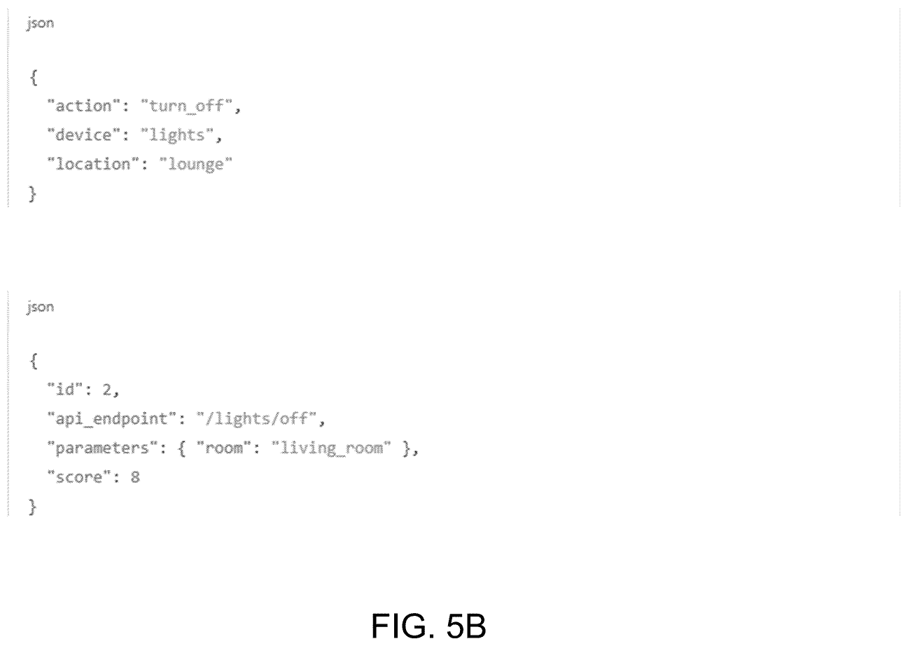

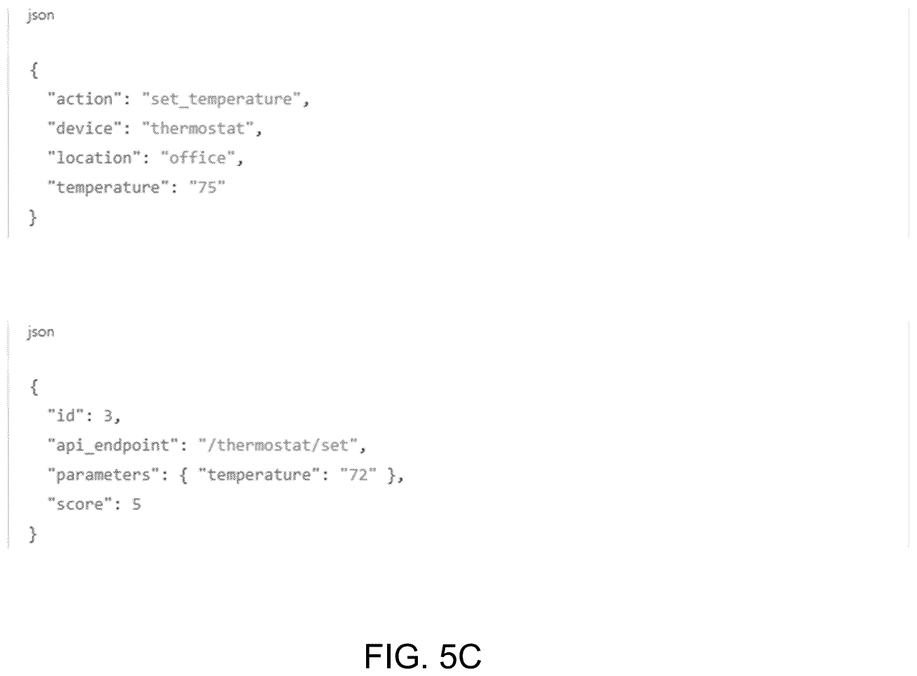

At step 404, the scoring system may assign a score for each candidate preset (which may be presets that show at least some similarity or may be any preset in the preset vector database) based on the scoring criteria described above. Under certain circumstances, a similarity comparison with a preset (e.g., “id”: 1) may find an exact match, and thus the preset is assigned the highest score (e.g., a score 11 as shown in FIG. 5A). Under certain circumstances, a similarity comparison with a preset (e.g., “id”: 2) may find a partial match, and thus the preset may be assigned a score lower than the highest score (e.g., a score 8 as shown in FIG. 5B). Under certain circumstances, a similarity comparison with a preset (e.g., “id”: 3) may find no good match, and thus the preset is assigned a really low score (e.g., a score 5 as shown in FIG. 5C). In this way, each candidate preset may have a corresponding score determined based on the similarity comparison.

At step 406, the scoring system may identify the best preset based on the score for each preset. According to some embodiments, the preset with the highest score (that is, the preset with “id”: 1) may be considered the best preset.

In some embodiments, to avoid executing incorrect actions, the scoring system may define a confidence threshold before triggering an API call. Under certain circumstances, even the preset with the highest score is not confident enough to pass the threshold, and thus the preset may be still not used to trigger the corresponding API call, even if the preset has the highest score determined by the scoring system. Under certain circumstances, the preset with the highest score that is below the threshold may be presented to the user to request a confirmation rather than executing an action with low confidence. Under certain circumstances, when the preset with the highest score is below the threshold, the system disclosed herein may ask the user to provide further clarification, so that a preset with the highest score greater than the threshold may be further searched and identified by the scoring system disclosed herein.

In some embodiments, the scoring system may also consider the priority and context in determining the best preset. For example, if a user says “turn off the lights,” the scoring system finds two exact matching presets, e.g., preset 1: “turn off all lights in the house” and preset 2: “turn off the lights in the living room.” If the user's last known location is the living room, the higher priority is given to the preset 2, and thus preset 2 is determined to be the best preset since it is more contextually relevant. For another example, if a user says “turn off the bedroom lights” and, a few minutes later, says “dim the lights to 50%,” the system may remember the last light-related command was for the bedroom. Since the user didn't specify a room in the second command, it assumes continuity and applies the dimming action to the bedroom lights, and thus the final decision may be “dim bedroom lights to 50%” instead of asking the user for clarification.

In some embodiments, the scoring system may use user profiles and device data for prioritization. For example, a user says “play my favorite music,” and the scoring system may find multiple presets, e.g., preset 1: “play favorite songs on the living room speaker,” and preset 2: “play favorite songs on the user's Bluetooth headphones.” If the user's Bluetooth headphones are connected, the preset 2 may be prioritized. On the other hand, if the command is issued at home after work, the preset 1 may be more relevant.

In some embodiments, the scoring system may also handle ambiguity with context awareness. For example, if a user says “star the meeting,” and the scoring system finds two matching presets, e.g., preset 1: “join the scheduled Zoom meeting at 3 PM,” and preset 2: “start a new Google Meet session,” to apply context to resolve ambiguity, the scoring system may look at the calendar and find that there is a Zoom meeting scheduled at the time point, the system may prioritize preset 1. If no scheduled meeting exists, the system may default to preset 2.

In some embodiments, there are other different means to allow to identify the best preset, all of which are contemplated by the present disclosure.

### API Call Execution

According to some embodiments, once the best preset is determined, the system may send the corresponding API request to an external system (e.g., Google Calendar, Slack, Salesforce, etc.), which handles its response appropriately. This step ensures that the mapped action is executed in the target system and provides error handling, authentication, and retries if needed.

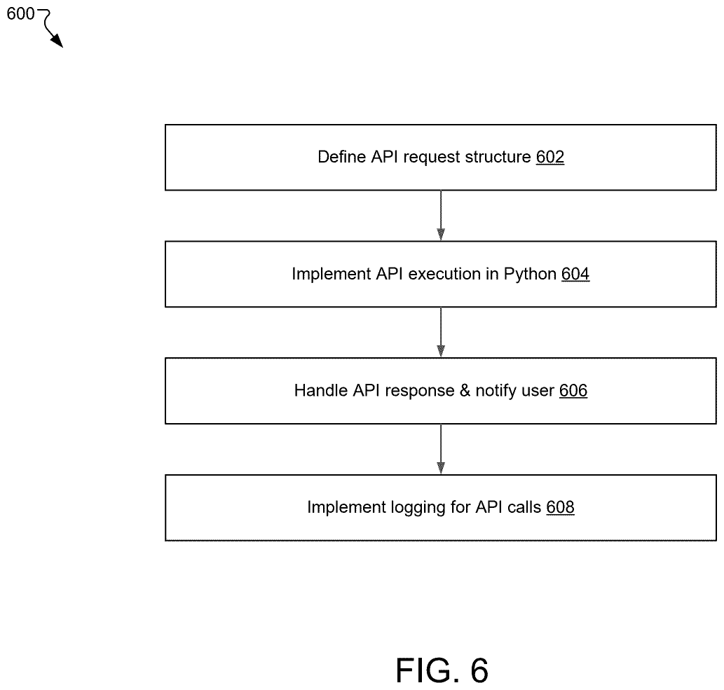

FIG. 6 illustrates an example method 600 for execution of an API call, according to some embodiments. Briefly, at step 602, the API request structure is defined or formatted. According to some embodiments, the API request consists of an API URL, a method, headers, and a body part. The API URL may be the endpoint where the request is sent (e.g., https://api.example.com/calendar/schedule). The HTTP method may be used, typically POST, GET, PUT, or DELETE, depending on the API action. The headers may contain authentication details, and the body part may contain parameters needed by the API (e.g., date, time, participants). According to some embodiments, when formatting the API call, specific parameters or values may be extracted from the best preset which incudes the parameters and corresponding actions required for formatting the API call.

At step 604, the API execution may be implemented in Python or in other different means, which is not limited in the disclosure. According to some embodiments, to send the API request, Python's requests library may be used, which may include sending the API request with necessary headers and payload, handling errors (e.g., authentication failure, timeout), and retiring the request if the external API fails temporarily.

At step 606, the API response may be obtained. According to some embodiments, once the API request is executed by the external system, the system disclosed herein may process the response and notify the user of the result. For example, a message “Action Confirmed: Meeting scheduled with John on Jun. 20, 2024, at 10:00 AM” may be sent to the user for the API request received from the user to schedule a meeting.

At step 608, logging for API calls may be implemented. According to some embodiments, every API request and response may be logged for audit tracking and debugging purposes.

While not shown in FIG. 6, in some embodiments, the action mapping system disclosed herein may further implement OAuth authentication for secure API calls. In one example implementation, to obtain OAuth authentication, a target application may be registered on Google Cloud Console or another similar platform. A Client ID and Client Secret may be further obtained, and then Redirect URI may be set up for authentication. In some embodiments, the access token may be further obtained by implementing OAuth flow, to allow all API requests to include the OAuth token. In some embodiments, the action mapping system disclosed herein may further implement Webhook handling for real-time updates. Instead of polling APIs frequently, webhooks may allow APIs to push updates to the system when events occur. In some embodiments, the action mapping system disclosed herein may implement asynchronous execution for scalable API calls. For high-performance applications, API requests may be run in the background without blocking the main process. In some embodiments, the action mapping system disclosed herein may implement additional functions not described above when making API calls.

### Overall Implementation

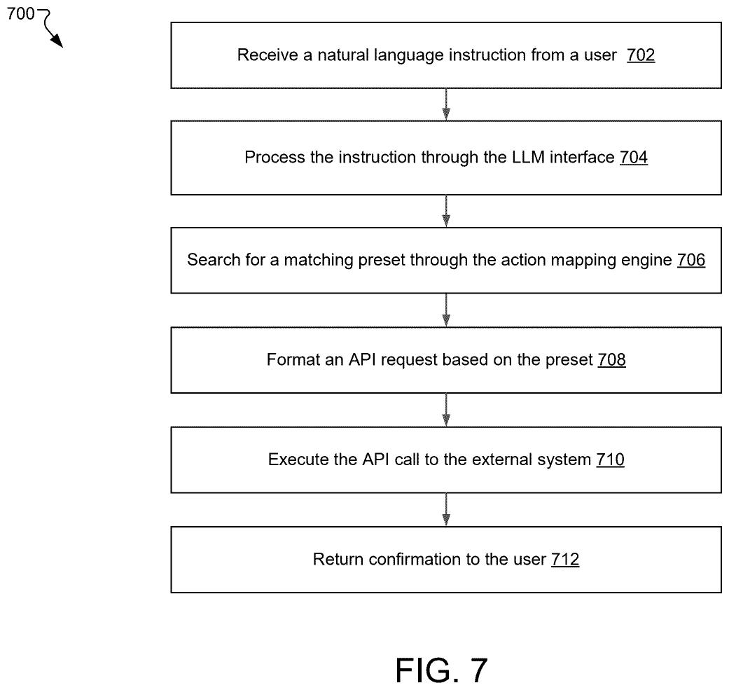

FIG. 7 illustrates an example method 700 of executing a preset based API call, according to some embodiments. Briefly, the method 700 begins at step 702 when a user submits a request via voice assistant, chatbot, CLI, or web API. As described earlier, the instruction may be provided in natural language, making it user-friendly. At step 704, the LLM interface analyzes the user input using natural language processing (NLP) tools to extract relevant parameters such as action type, entity, and time. At step 706, the action mapping engine searches for a matching preset. For example, the action mapping engine may compare the extracted parameters against a preset database (e.g., preset vector database 112) to find the best matching preset (or best API action included in the corresponding preset). At step 708, the API request (also referred to as an API call) is formatted based on the best preset. For example, once a matching preset is found, the system formats an API request by combining extracted parameters with default values from the preset to format the API request. At step 710, the API call to the external system is executed. For example, the action mapping system may send the formatted API request (or API call) to the external API endpoint (e.g., to schedule a meeting if the request received from the user is to schedule a meeting). At step 712, a confirmation is returned to the user in response to the request. That is, after executing the API call, the action mapping system notifies the user of the result.

Implemented in this way, the preset based action mapping system may enhance accuracy, consistency, and efficiency by mapping natural language instructions to predefined API calls. Unlike traditional AI-driven API execution, which relies on real-time interpretation and may lead to inconsistencies, this system ensures standardized and error-free API interactions. By storing predefined action-parameter mappings, the system may eliminate the need for users to manually configure API requests, reducing human errors and streamlining automation. This approach may make API interactions more accessible, allowing even non-technical users to execute complex API calls effortlessly. Additionally, faster response times may be achieved by eliminating real-time processing overhead, making the system more scalable for enterprise-level automation.

Beyond efficiency, the preset based action mapping system may also improve security and reliability. Since API actions are predefined and structured, there is less risk of incorrect API usage or security vulnerabilities. When combined with OAuth authentication, it may ensure that only authorized users can trigger specific API actions, protecting sensitive data. The integration of webhook-based event handling may further enhance performance by enabling real-time updates instead of relying on inefficient API polling. Additionally, the system's logging and error-handling mechanisms provide transparency and reliability, ensuring that every API call is monitored, retried if necessary, and properly recorded for auditing and debugging. By offering scalability, security, and user-friendly automation, the preset based action mapping system is a powerful tool for modern API-driven applications. Some specific applications of the disclosed preset based action mapping system are further described hereinafter.

### Example Applications

In the following, the example applications for action presets for intent driving action mapping are further described. It should be noted that the following applications are merely for exemplary purposes and not for limitations.

### Voice-Controlled Automation

In one example, the action presets for intention-driving action mapping may be used for voice-controlled automation, such as smart home or Internet-of-Things (IoT). For example, a user may give a voice command, and the system disclosed here may trigger predefined API actions dynamically. The example voice commands may include but are not limited to, “turn on the lights at 8 pm,” “dim the bedroom lights,” “lock the front door,” “turn on the security alarm,” “set the thermostat to 72° F.,” “turn on the AC in the living room,” etc.

Briefly, the application may include voice input processing, which includes the capture of voice commands via a microphone, mobile app, or smart speaker, and then a conversion of the captured voice commands into text through a speech-to-text application such as OpenAI Whisper, Google Speech-to-Text, Azure Speech API, etc. Next, the LLM interface and the LLM-based action mapping engine may process the text command using an LLM (GPT, Claude, Llama, etc.) and match the command with the closest preset automaton action, as described earlier. The closest preset automation action may be selected from a preset action database, such as the preset vector database 112 as also described earlier. After the matching, the API triggering may be implemented to call the appropriate smart home API endpoint based on the matched preset. The interfaces for API triggering may include but are not limited to HTTP RESTful APIs, WebSockets, or MQTT protocols.

### Intelligent Chatbot Integrations

In one example, the action presets for intention-driving action mapping may be used for intelligent chatbot integration. This implementation enables a customer support chatbot to understand user queries and map them to preset API responses using an LLM-powered action mapping system disclosed herein. For example, a user query “how do I reset my password” may be mapped to a preset API response. Other example queries may include but are not limited to “how do I contact customer service,” “I need help with my bill,” “where I can check my order,” etc.

Briefly, the user query processing system may capture text-based queries from web chat, mobile apps, or messaging platforms (e.g., WhatsApp, Telegram, Slack, etc.). Optionally, voice input may be converted to text using speech-to-text APIs as described above. The LLM-based query mapping engine may then process the text command using an LLM (GPT, Claude, Llama, etc.) and match the command with the closest preset response action. The closest preset response action may be selected from a preset response database that stores predefined support responses. After the matching, the API triggering may be implemented to call the appropriate customer support API endpoint based on the matched preset. The interfaces for API triggering may include but are not limited to HTTP RESTful APIs, WebSockets, or chat platform webhooks.

### DevOps & API Management

In another example, the action presets for intention-driving action mapping may be used for DevOps & API management. This implementation may automate DevOps workflows by mapping human instructions to preset API-based automation actions. This AI-powered DevOps automation may allow users to trigger continuous integration and continuous deployment (CI/CD) pipelines, infrastructure changes, and system monitoring tasks using natural language commands. Example DevOps automation actions may include but are not limited to CI/CD deployment (e.g., “deploy the latest version of the app,” “rollback the app to version 2.1,” “deploy the staging environment,” etc.), infrastructure management (e.g., “restart the database server,” “scale the API service to 3 instances,” “provision a new EC2 instance,” etc.), and monitoring & logs (e.g., “check the status of Kubernetes cluster,” “show the latest 50 log entities,” “trigger an alert if CPU usage exceeds 80%,” etc.)

Briefly, user commands in text or voice may be captured using CLI, chat interfaces (e.g., Slack, Teams), or voice assistants. Optionally, if voice commands are captured, they can be converted to text using OpenAI Whisper or Google Speech-to-Text, etc. The LLM-based action mapping engine may then process the text command using an LLM (GPT, Claude, Llama, etc.) and match the command with the closest preset DevOps automation action. The closest preset DevOps action may be selected from a preset DevOps database that stores predefined DevOps automation actions. After the matching, the API triggering may be implemented to call the appropriate DevOps API endpoint, e.g., send API request to DevOps tools, such as Kubernetes, AWS Lambda, Jenkins, GitHub Actions, Terraform, etc. The interfaces for API triggering may include but are not limited to ESTful APIs, Webhooks, or CLI execution.

### Enterprise Workflow Automation

In another example, the action presets for intention-driving action mapping may be used for enterprise workflow automation. This implementation may automate repetitive enterprise tasks, where natural language instructions trigger preset reporting, data analysis, and workflow automation actions. Example enterprise automation actions may include but are not limited to “generate a sale report for Q1,” “schedule a meeting for next Wednesday,” “approve budget request for R&D department,” etc.

Briefly, text or voice-based user queries may be captured through emails, Slack, Web UI, chatbot, etc. The LLM-based action mapping engine may then process the text command using an LLM (e.g., GPT, Claude, Llama, etc.) and match the command with the closet preset enterprise action. The closest preset enterprise action may be selected from a preset enterprise workflow action database that stores predefined enterprise automation tasks. After the matching, the API triggering may be implemented to call business process APIs, such as Salesforce, Power BI, Google Calendar, Workday, ServiceNow, etc. This AI-powered automation system may transform how businesses handle enterprise workflows, thereby improving efficiency and reducing manual workload.

### Computer-Based Implementations

In some examples, some or all of the processing described above can be carried out on a personal computing device, on one or more centralized computing devices, or via cloud-based processing by one or more servers. Some types of processing can occur on one device and other types of processing can occur on another device. Some or all of the data described above can be stored on a personal computing device, in data storage hosted on one or more centralized computing devices, and/or via cloud-based storage. Some data can be stored in one location and other data can be stored in another location. In some examples, quantum computing can be used, and/or functional programming languages can be used. Electrical memory, such as flash-based memory, can be used.

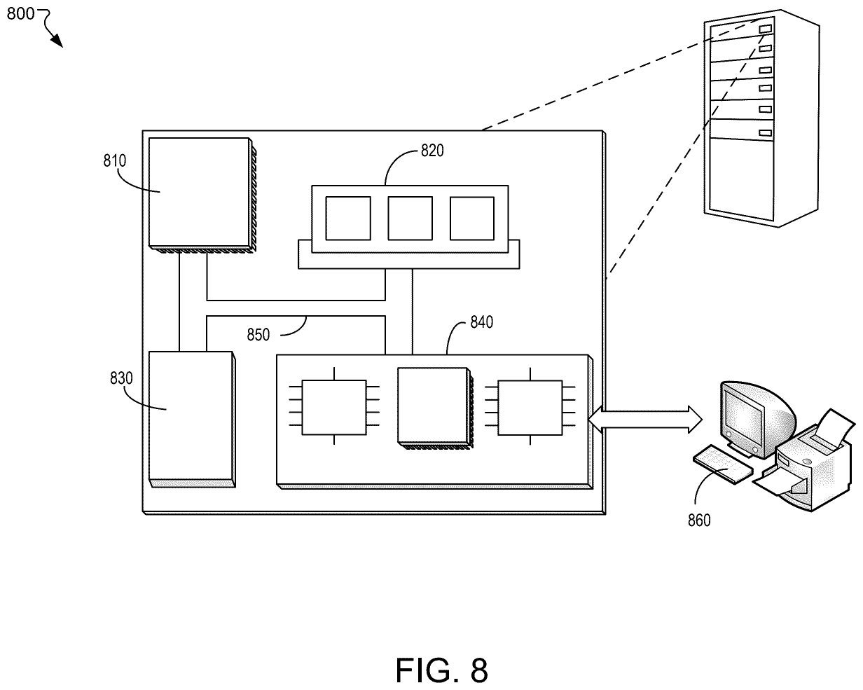

FIG. 8 is a block diagram of an example computer system 800 that may be used in implementing the technology described herein. General-purpose computers, network appliances, mobile devices, or other electronic systems may also include at least portions of the system 800. The system 800 includes a processor 810, a memory 820, a storage device 830, and an input/output device 840. Each of the components 810, 820, 830, and 840 may be interconnected, for example, using a system bus 850. The processor 810 is capable of processing instructions for execution within the system 800. In some implementations, the processor 810 is a single-threaded processor. In some implementations, the processor 810 is a multi-threaded processor. The processor 810 is capable of processing instructions stored in the memory 820 or on the storage device 830.

The memory 820 stores information within the system 800. In some implementations, the memory 820 is a non-transitory computer-readable medium. In some implementations, the memory 820 is a volatile memory unit. In some implementations, the memory 820 is a non-volatile memory unit.

The storage device 830 is capable of providing mass storage for the system 800. In some implementations, the storage device 830 is a non-transitory computer-readable medium. In various different implementations, the storage device 830 may include, for example, a hard disk device, an optical disk device, a solid-state drive, a flash drive, or some other large-capacity storage device. For example, the storage device may store long-term data (e.g., database data, file system data, etc.). The input/output device 840 provides input/output operations for the system 800. In some implementations, the input/output device 840 may include one or more network interface devices, e.g., an Ethernet card, a serial communication device, e.g., an RS-232 port, and/or a wireless interface device, e.g., an 802.11 card, a 3G wireless modem, or a 4G wireless modem. In some implementations, the input/output device may include driver devices configured to receive input data and send output data to other input/output devices, e.g., keyboard, printer, and display devices 860. In some examples, mobile computing devices, mobile communication devices, and other devices may be used.

In some implementations, at least a portion of the approaches described above may be realized by instructions that upon execution cause one or more processing devices to carry out the processes and functions described above. Such instructions may include, for example, interpreted instructions such as script instructions, executable code, or other instructions stored in a non-transitory computer-readable medium. The storage device 830 may be implemented in a distributed way over a network, such as a server farm or a set of widely distributed servers, or may be implemented in a single computing device.

Although an example processing system has been described in FIG. 8, embodiments of the subject matter, functional operations, and processes described in this specification can be implemented in other types of digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible nonvolatile program carrier for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to a suitable receiver apparatus for execution by a data processing apparatus. The computer storage medium can be a machine-readable storage device, a machine-readable storage substrate, a random or serial access memory device, or a combination of one or more of them.

The term “system” may encompass all kinds of apparatus, devices, and machines for processing data, including by way of example a programmable processor, a computer, or multiple processors or computers. A processing system may include special-purpose logic circuitry, e.g., an FPGA (field programmable gate array) or an ASIC (application-specific integrated circuit). A processing system may include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a standalone program or as a module, component, subroutine, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Computers suitable for the execution of a computer program can include, by way of example, general or special purpose microprocessors or both, or any other kind of central processing unit. Generally, a central processing unit will receive instructions and data from a read-only memory, a random access memory, or both. A computer generally includes a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few.

Computer readable media suitable for storing computer program instructions and data include all forms of non-volatile memory, media, and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special-purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's user device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of the client and server arises by virtue of computer programs running on the respective computers and having a client-server relationship with each other.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other steps or stages may be provided, or steps or stages may be eliminated, from the described processes. Accordingly, other implementations are within the scope of the following claims.

### Terminology

The phraseology and terminology used herein are for the purpose of description and should not be regarded as limiting.

The term “approximately”, the phrase “approximately equal to”, and other similar phrases, as used in the specification and the claims (e.g., “X has a value of approximately Y” or “X is approximately equal to Y”), should be understood to mean that one value (X) is within a predetermined range of another value (Y). The predetermined range may be plus or minus 20%, 10%, 5%, 3%, 1%, 0.1%, or less than 0.1%, unless otherwise indicated.

The indefinite articles “a” and “an,” as used in the specification and in the claims, unless clearly indicated to the contrary, should be understood to mean “at least one.” The phrase “and/or,” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of or “exactly one of,” or, when used in the claims, “consisting of,” will refer to the inclusion of exactly one element of a number or list of elements. In general, the term “or” as used shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The use of “including,” “comprising,” “having,” “containing,” “involving,” and variations thereof, is meant to encompass the items listed thereafter and additional items.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

Each numerical value presented herein, for example, in a table, a chart, or a graph, is contemplated to represent a minimum value or a maximum value in a range for a corresponding parameter. Accordingly, when added to the claims, the numerical value provides express support for claiming the range, which may lie above or below the numerical value, in accordance with the teachings herein. Absent inclusion in the claims, each numerical value presented herein is not to be considered limiting in any regard.

The terms and expressions employed herein are used as terms and expressions of description and not of limitation, and there is no intention, in the use of such terms and expressions, of excluding any equivalents of the features shown and described or portions thereof. In addition, having described certain embodiments of the invention, it will be apparent to those of ordinary skill in the art that other embodiments incorporating the concepts disclosed herein may be used without departing from the spirit and scope of the invention. The features and functions of the various embodiments may be arranged in various combinations and permutations, and all are considered to be within the scope of the disclosed invention. Accordingly, the described embodiments are to be considered in all respects as only illustrative and not restrictive. Furthermore, the configurations, materials, and dimensions described herein are intended as illustrative and in no way limiting. Similarly, although physical explanations have been provided for explanatory purposes, there is no intent to be bound by any particular theory or mechanism, or to limit the claims in accordance therewith.

What is claimed is:

1. A method for action preset based application programming interface (API) call, comprising:
receiving a natural language instruction from a user;
processing the natural language instruction to extract a set of parameters through a large language model (LLM);
comparing the extracted parameters against a preset database to find a matching action preset;
formatting an API request by combining the extracted parameters with default values obtained from the matching action preset; and
sending the formatted API request to an external API endpoint to execute the API request.

2. The method of claim 1, wherein the matching action preset is identified from a plurality of action presets in the preset database based on ranking.

3. The method of claim 2, wherein an action preset in the preset database includes a combination of one or more parameters and an associated action.

4. The method of claim 2, wherein an action preset in the preset action database is obtained by:
obtaining historical user interaction data;
analyzing the historical user interaction data to determine a frequency of an action-parameter combination;
determining the action-parameter combination to be a common combination when the frequency of the action-parameter combination exceeds a predefined threshold;
structuring the common combination into a preset entity;
validating the preset entity; and
saving the validated preset entity in the preset database as the action preset.

5. The method of claim 4, wherein the preset entity has a unique preset identification and a corresponding action identification.

6. The method of claim 4, further comprising:
categorizing parameters included in the preset entity into static parameters or dynamic parameters based on a commonality and potential for user customization.

7. The method of claim 6, wherein validating the preset entity comprises:
checking whether static values for the static parameters are filled in for a static preset or the dynamic parameters are correctly marked for a dynamic preset.

8. The method of claim 1, wherein formatting the API request comprises:
formatting an API URL, a method, headers, and a body part of the API request, wherein the API URL is an endpoint to which the API request is sent.

9. The method of claim 1, wherein comparing the extracted parameters against the preset database to find the matching action preset comprises:
defining a scoring criteria to score an action preset in the preset database for the received user request;
assigning a score for each action preset in the preset database based on the scoring criteria; and
determining an action preset with a highest score as the matching action preset.

10. The method of claim 1, wherein the matching action preset is determined based on context or priority information associated with the natural language instruction.

11. A system for for action preset based API call, comprising:
a processor; and
a memory in communication with the processor and comprising instructions which, when executed by the processor, program the processor to:
receive a natural language instruction from a user;
process the natural language instruction to extract a set of parameters through an LLM;
compare the extracted parameters against a preset database to find a matching action preset;
format an API request by combining the extracted parameters with default values obtained from the matching action preset; and
send the formatted API request to an external API endpoint to execute the API request.

12. The system of claim 11, wherein the matching action preset is identified from a plurality of action presets in the preset database based on ranking.

13. The system of claim 12, wherein an action preset in the preset database includes a combination of one or more parameters and an associated action.

14. The system of claim 12, wherein the instructions further program the processor to:
obtain historical user interaction data;
analyze the historical user interaction data to determine a frequency of an action-parameter combination;
determine the action-parameter combination to be a common combination when the frequency of the action-parameter combination exceeds a predefined threshold;
structure the common combination into a preset entity;
validate the preset entity; and
save the validated preset entity in the preset database as the action preset.

15. The system of claim 14, wherein the instructions further program the processor to:
categorize parameters included in the preset entity into static parameters or dynamic parameters based on a commonality and potential for user customization.

16. The system of claim 15, wherein the instructions further program the processor to:
check whether static values for the static parameters are filled in for a static preset or the dynamic parameters are correctly marked for a dynamic preset.

17. The system of claim 11, wherein the instructions further program the processor to:
format an API URL, a method, headers, and a body part of the API request, wherein the API URL is an endpoint to which the API request is sent.

18. The system of claim 11, wherein the instructions further program the processor to:
define a scoring criteria to score an action preset in the preset database for the received user request;
assign a score for each action preset in the preset database based on the scoring criteria; and
determine an action preset with a highest score as the matching action preset.

19. The method of claim 1, wherein the matching action preset is determined based on context or priority information associated with the natural language instruction.

20. A computer program product for automatic data retrieval and synchronization, the computer program product comprising a non-transitory computer-readable medium having computer readable program code stored thereon, the computer readable program code configured to:
obtain historical user interaction data;
analyze the historical user interaction data to determine a frequency of an action-parameter combination;
determine the action-parameter combination to be a common combination when the frequency of the action-parameter combination exceeds a predefined threshold;
structure the common combination into a preset entity;
validate the preset entity; and
save the validated preset entity in the preset database as the action preset.
